(19) United States
(12) Patent Application Publication
(10) Pub. No.: US 2020/0070249 A1
(43) Pub. Date: Mar. 5, 2020

(54) METHOD AND APPARATUS FOR FINISHING COMPLEX AND CURVED SURFACES USING A CONFORMAL APPROACH FOR ADDITIVELY MANUFACTURED PRODUCTS AND OTHER PARTS, AND THE RESULTANT PRODUCTS

(71) Applicant: OBERG INDUSTRIES, Freeport, PA (US)

(72) Inventors: O. BURAK OZDOGANLAR, SEWICKLEY, PA (US); JOSEPH A. DEANGELO, CHESWICK, PA (US)

(73) Assignee: OBERG INDUSTRIES, FREEPORT, PA (US)

(21) Appl. No.: 16/120,576

(22) Filed: Sep. 4, 2018

(51) Int. Cl. B22F 3/24; C25F 3/16; B22F 3/105

(52) U.S. Cl. CPC B22F 3/24; C25F 3/16; B33Y 10/00; B22F 2003/247; B22F 2003/1057; B22F 3/1055

(57) ABSTRACT

A method and apparatus for conformal surface finishing and/or forming of additive manufactured products and an improved system for a combined electrolytic removal of material followed by precise mechanical cleaning and removal of excess material to create improved precision in a single stage without requiring the use of a grinding wheel. An automated computerized embodiment is disclosed.

### BACKGROUND OF THE INVENTION

### 1. Field of the Invention

A method and apparatus for material removal and surface finish improvement of three-dimensional metal and other electrically conductive products employing a novel electro-chemical-mechanical process, referred to as the conformal molecular decomposition process (C-MDP) on electrically conductive products, and related products produced thereby.

### 2. Description of the Prior Art

There have been numerous known methods for producing three-dimensional metal products (and other products made of electrically conductive material) through multi-stage fabrication techniques. The known methods for shaping and finishing these products tend to be complex and costly to employ. A problem with prior systems is the time consuming and labor intensive multi-step finishing processing needed to obtain the desired product surface quality. Many complex and curved products, such as the majority of metal parts produced by additive manufacturing (AM) and casting products, require multiple non-standard finishing processes in order to satisfy the surface quality requirements. Unfortunately, this adds significantly to the cost and lead-time for manufacturing such parts, and discourages the use of advanced manufacturing techniques such as Additive Manufacturing (AM).

The electrochemical grinding (ECG) process was originally developed a few decades ago for shaping and finishing metal components that are very difficult and costly to machine (e.g. titanium, Inconel). The process synergistically combines electrochemical and mechanical (abrasive) material removal mechanisms for effective material removal from conductive materials with a very high level of control. The electrochemical material removal action is similar to that of the electrolysis process. In the presence of a sufficiently small gap containing electrolyte, a negatively-charged conductive matrix (cathode) of the grinding wheel effects removal of the material from a positively-charged workpiece (anode) surface through the current built up within the gap. Although this material removal action is inherently of very high precision (a material is removed in atomic—or molecular—units), the newly formed surface also oxidizes, thereby passivating the surface. For this reason, highly reactive electrolytes are required to facilitate continuing material removal. Even when those reactive electrolytes, which may be dangerous for the operator and very harmful to the environment, are used, the overall material removal rate is small.

To alleviate this issue, abrasive grits are incorporated into the cathode (grinding wheel). The insulating abrasive grits enable removing the passivated layer from the workpiece surface mechanically and facilitate retaining a stable gap between the anode and cathode.

FIG. 1 shows schematically an ECG grinding wheel 2 having a plurality of embedded outwardly projecting abrasive grit elements 4, 6, 8, for example, which enter the space between the workpiece 10 and the region within which the electrolyte 12 flows. The region where the electrochemical action takes place has been indicated generally by the letter EC. The region where mechanical action to remove material occurs has been indicated generally by the letter G, indicating “grinding”. The combined electrochemical and mechanical action has been indicated general it might be letters G+EC. The dashed line 12 represents the newly formed surface by the ECG grinding wheel form the workpiece 10.

As the passivated thin layer is either softer than the base conductive material (metal) and/or weakly bound to the base material, the mechanical removal of the passivating layer by the abrasive grit elements is very efficient and induces minimal force (FIG. 1). This results in the force experienced on the base material during the process to be one to two orders less than that experienced in a mechanical grinding process with comparable process parameter. The reaction byproducts produced during the process pollute the electrolyte, reduce its conductivity, and prevent building sufficient levels of electrical charge between the tool and the workpiece. As such, they should be removed from the process zone (i.e., the gap), and clean electrolyte must be presented to the gap. The grinding wheel 2 rotates and translates with workpiece being stationary, along with the forced supply of electrolyte, enables the continuous refreshing of electrolyte. In sum, if well controlled, the ECG process produces little-to-no heat, very small mechanical force, very large range of material removal rates (from simply polishing the surface to aggressive removing a large amount of material), minimal tool wear, and outstanding surface roughness and quality. As such, potential efficiency and effectiveness of the ECG process is well above the sum of individual electrochemical and mechanical processes.

Until about a decade ago the ECG process had not been well-controlled, leading to inefficient process characteristics, environmentally harmful process by-products, considerable usage of consumables (electrolyte and grinding wheels), intensive labor needs that were heavily dependent on the operator experience, and low surface quality. One of the main drawbacks of the ECG process has been the lack of capability to control many different electrical and mechanical parameters of the process to enable precise and high-efficiency material removal. In order to function efficiently, the process has to be carefully controlled to retain an optimal gap, feed rate, and electrolyte flow/cleanliness. Another issue has been the environmental concerns as the traditional ECG process results in creation of harmful by-products, such as hexavalent chrome. As such, while there had been considerable interest in this very promising process, broad utilization of the process has been significantly retarded.

A number of process innovations that were created beginning from about a decade ago brought an advanced form of the ECG process, referred to as the Molecular Decomposition Process (MDP), back into the focus. Oberg Industries, co-owner of the present application, acquired and developed technology that enabled controlling the process at an unprecedented level, realizing precise material removal and outstanding surface quality at high material removal rates in an environmentally friendly manner. To this end, they created optimal grinding wheels with judicious choice of conductivity and abrasive particles as to size, distribution, and choice of abrasive material and the manner in which abrasives were incorporated into the wheel. An electrolyte management system that enables obtaining clean electrolyte and delivering it at the right flow rate and conductivity was created. A power control system with a model-based mathematical algorithm that monitors spindle power and gap current to realize optimal material removal by sustaining an optimal gap distance while the abrasive particles were still removing the passivated material was also created.

Referring to FIG. 2, the MDP system is shown schematically. A grinding wheel 20 (cathode) is disposed in spaced relationship with workpiece 22 with electrolyte being delivered at a predetermined rate between the grinding wheel 20 and the workpiece (anode) 22 by a nozzle 24. The workpiece 22 is supported on a table 26, which enables setting the removal depth as well as prescribing the feed motions between the wheel and the workpiece. Grinding wheel 20 is negatively charged as the cathode and the workpiece is electrically isolated from table 26 and positively charged as the anode.

Thermal and mechanical deflections caused by the process have been shown to be at negligible levels. No smearing or ploughing has been observed on the surfaces, and the surface chemistry was not altered due to the process. Surface roughness values below 25 nm Ra have been obtained on many different materials. Three-to-five times higher material removal rates have been obtained as compared to the mechanical grinding process, while producing minimal tool wear and low energy consumption. Through these innovations, electrolytes based on simple salt solutions could be used, and no harmful metal by-products are created during the process. Many hard-to-machine materials (e.g., Ti, CoCr, Stainless Steel, Inconel) and other electrically-conductive materials can be ground and/or polished using this approach. The forces are extremely low (less than 10% of mechanical grinding); and surface finishes as good as 10 s of nanometer Ra can be obtained. The process has been used to fabricate industrial components, such as gears and surgical tools. The MDP process has been shown to be superior to other finishing processes for conductive workpiece materials.

In this invention, an advanced MDP process, referred to as the Conformal Molecular Deposition Process (C-MDP) is described to enable finishing complex and/or curved electrically-conductive parts efficiently and effectively. C-MDP process possesses all the benefits of the MDP process when using a traditional grinding wheel configuration and expands it by enabling automated finishing of curved and complex 3D parts.

To date, no one-step, effective and efficient finishing process has been demonstrated for parts with complex and/or curved 3D (and arbitrary) geometries, such as those fabricated by additive manufacturing. For instance, additively manufactured metal parts typically exhibit surface roughness of the order of 500 μm Ra or higher depending on the AM process used, the part geometry and the processing parameters. Increased surface roughness is a result of two different mechanisms acting on the part when it is being built. They are (a) “stair step” effect—seen on inclined or curved geometries, caused by the finite layer thickness; and (b) “balling” phenomenon—caused by decrease in free energy which results in discontinuous scan tracks leading to increased surface roughness. Furthermore, the material properties of the surfaces are commonly non-uniform and include non-ideal characteristics, such as white-layer formation and tensile residual stresses. A range of surface modification techniques have been explored in literature to address these issues: they can be classified based on their mechanism of action, including (1) material removal by mechanical means such as CNC machining, grinding, or abrasive flow machining; (2) surface smoothening by thermal processes such as laser polishing and electron beam irradiation; and (3) chemical and electrochemical techniques such as electrochemical polishing and acid etching.

Earlier in 2001, Ramos et al. “Surface roughness enhancement of indirect-SLS metal parts by laser surface polishing” in Solid Freeform Fabrication Proceedings (pp. 28-38) used high powered Nd: YAG and CO₂ based laser process to polish 420 Stainless Steel (SS) produced by Selective Laser Sintering (SLS). Speed and power of the laser was varied to achieve a reduction in Ra from 2.38 μm to 0.8 μm.

In another study by Mingareev et al., “Femtosecond laser post processing of metal parts produced by laser additive manufacturing” 2013 Journal of Laser Applications 25 (5), 052009) high repetition rate femtosecond laser radiation was used to smoothen the surface of Ti6Al4V samples made from Selective Laser Melting (SLM). Processing higher number of layers with smaller vertical steps helped in achieving a finish under 3 μm from an initial roughness (Ra) of 22 μm. Although the laser processing can improve the surface finish of additively manufactured parts, surface quality may considerably degrade due to the thermal stresses, creation of recast layer, and control of laser focal length. Furthermore, laser surface finishing can be relatively slow with respect to other finishing processes, and attainable and repeatable surface roughness is limited to approximately 1 μm Ra.

Lober et al. “Comparison of different post processing technologies for SLM generated 3161 steel parts” in 2013 Rapid Prototyping Journal, 19(3), 173-179 compared different post processing techniques such as grinding, sand blasting and electrolytic and plasma polishing for improving the surface roughness of 316L SS cubes built by SLM. He found that some of the processes such as grinding and sand blasting are only usable for simple structures, whereas complex parts needed more advanced techniques such as electrolytic polishing (which is the same as the electrochemical removal). Better results were obtained when a combination of multiple processes was used leading to a reduction in Ra from 15 μm to 0.12 μm.

Similarly, Spierings et al. “Fatigue performance of additive manufactured metallic parts” in 2013 Rapid Prototyping Journal, 19(2), 88-94 used CNC machining to reduce the surface roughness of additively manufactured 316L SS samples from 10 μm to 0.4 μm and further used hand polishing via buffing wheel to achieve roughness of 0.1 μm (Ra). These works attest to the fact that a combination of the mechanical and chemical/electrochemical finishing process is very promising in attaining good surface quality. However, none of the aforementioned processes can compete with the material removal rate, flexibility, and attainable surface quality of the C-MDP process.

Recently, a novel iteration of the traditional grinding process in the form of shape adaptive grinding was introduced by Beaucamp et al. “Finishing of additively manufactured titanium alloy by shape adaptive grinding” in 2015 Surface Topology: Metrology and Properties, 3(2), 024001 in which a spherically shaped elastic tool is covered with nickel-bonded or resin bonded-diamond pellets. The deformability of the elastic tool allows it to conform to the freeform surfaces. Surface finish down to 10 nm was achieved by progressively changing the tool with smaller sized diamond pellets on a TitAl4V sample made by SLS. This finishing process introduced a shape variation of ±5 μm and has some usability limitations on concave samples having small radius of curvatures. Again, this work demonstrates the potential promise of using a conformal tool, however, has not produced industrially applicable and reproducible results, and considerably less favorable than our proposed C-MDP process as disclosed in all aspects, such as force, thermal deflections and attainable surface quality.

Atzeni et al. “Abrasives Fluidized Bed (AFB) Finishing of AlSi10Mg Substrates Manufacturing by Direct Metal Laser Sintering. (DMLS)” in 2016 Additive Manufacturing, 10, 15-23 explored the feasibility of abrasive fluidized bed method to finish flat AlSi10Mg substrates fabricated by AM. Three different shapes of abrasive particles were used, one at a time to machine the substrates by rotating it at different frequencies. Final surface finish of 1.5 μm (Ra) could be achieved with this process at a cost of rounding the workpiece edges. The process controllability and repeatability have not been established.

Geddam et al “An Assessment of the Influence of some Wheel Variables in Peripheral Electrochemical Grinding” Int. J. Mach Des. Res., pp 1-12 (1971) discloses experimental work dealing with electrochemical grinding using sodium nitrite as the electrolyte and seeking to evaluate various types of grinding wheels having impregnated aluminum oxide abrasives. The abrasives are disposed in a metal bond. Metal bond aluminum oxide grit wheels were deemed to not be suitable for mechanical removal. The metal bond wheels were also deemed more susceptible to spark damage than the formable bond wheels. The surface finish of nimonic 105 employing a 10 percent solution of sodium nitrite as electrolyte was concluded to improve surface finish with decreasing voltage and increasing feed rate.

C. F. NOBLE, “ Electro-Mechanical Action in Peripheral Electrochemical Grinding”, Annals of the CIRP, Vol 32/1/1983, pp 123-127 discloses extensive calculations seeking to determine inter-electrode gap values as related to machining parameters such as depth of cut.

Most of the additively manufactured samples used in the surveyed literature were rather simple geometries and not complex parts. The surface modification steps for a complex functional part is not yet clear, but it may be concluded that a single process is often inadequate, but a combination of processes, including customized processes, is typically required to achieve adequate polishing performance in terms of functional surface finish and processing times.

In spite of the foregoing prior art systems involving material removal as a means in a multi-stage process of producing three-dimensional metal products, there, nevertheless, remains a substantial need for an efficient system which can, with precision, produce a smooth, precisely dimensioned complex shaped product in a single step. To this end, the C-MDP approach is considerably superior to the prevailing alternative surface finishing techniques and brings transformative advances to the way the desired surface finish of complex and curved electrically-conductive parts (including metals), such as additively manufactured metal parts, can be achieved.

### SUMMARY OF THE INVENTION

The present invention, C-MDP, provides a substantial improvement over the hereinbefore described MDP process through the elimination of the rigid grinding wheel and the substitution of uniquely configured conformal heads, such as brushes with conductivity and abrasive particles, abrasive-impregnated elastic-based tooling, or inflatable tooling, which facilitate more effective creation of complex conformal molecular decomposition products with great precision. Negatively charged conformal tool acts on a positively charged workpiece. This is accomplished in a single step. Some part of the tooling, such as some of the brush bristles, may be electrically conductive whereas the others may be inert.

In one embodiment when using a brush tool (conductive and abrasive), the brush rotates at a rapid speed and facilitates maintaining the optimum gap. The abrasive portions of the brush, which may or may not also be conductive, serve to remove the passivating layer and other sludge or mud from the workpiece surface. The rotating brushes rotate about a horizontal shaft or a generally vertically oriented shaft or any other practical, desired angular position. Multiple conformal tools may be used simultaneously or in series on a workpiece.

In its broader aspects, a negatively charged conformal movable head, which may consist of brushes or other conformable “tooling” with a power driven or other movable heads are structured to contact and to remove surface material, sludge and debris as well as undesired coatings from the surfaces of workpieces. The movable head cooperates with an electrically conductive workpiece, which is the anode. A gap is defined between the cathode movable head and the anode with electrolytes flowing between the removable head and to the workpiece. Electrically nonconductive abrasives are secured in or attached to or impregnated in the conformal movable tool in order to remove overlying sludge and ultimately be oxidized later cause by the electrochemical reaction created by the electrolyte, which flows in a gap defined between conformable movable head and the workpiece. Relative movement between the conformal tool and the workpiece initially permits electrolytic action to remove material from the workpiece and sequentially permits the nonconductive abrasives mechanically remove portions of the workpiece. The net result of such action is substantial improvement of the surface quality of the workpiece and exposing the base material composition, which achieves improved surface quality in a cost-effective manner.

As a result, this combination of the process and the system improves the quality of the workpiece by improving its dimensional and/or surface quality and exposing the base material composition, thereby providing improved surface quality in a cost-effective manner.

All of the foregoing is effected in a precise efficient manner to produce C-MDP Products of comparable or better surface finish quality than those obtained from the prior system of MDP.

It is an object of the present invention to employ C-MDP for improving the surface of metal parts fabricated using AM and/or other additive manufacturing (AM) techniques to create parts of simple or complex geometry.

It is also an object of the present invention to employ C-MDP for improving the surface of electrically conductive parts fabricated using any manufacturing technique to create parts of simple or complex geometry.

It is a further object of the present invention to employ C-MDP in the rapid finishing of complex surfaces in a single step and/or in a single or multiple setups.

It is a further object of the present invention to produce metal AM products with very smooth surfaces.

It is a further object of the invention to clean surfaces, remove oxides and other dirt, and remove burrs from parts.

It is a further object of the present invention to produce metal or other electrically-conductive products with very smooth surfaces.

It is an object of the present invention to produce precision parts which cannot be produced by the traditional electrochemical grinding (ECG) process or the MDP process without the need for custom processes and setups.

It is a further object of the present invention to provide a process and apparatus for employing C-MDP to rapidly produce accurate AM fabricated metal or conductive parts and to rapidly produce accurate parts fabricated by other manufacturing processes.

It is yet another object of the present invention to produce complex metal AM parts through methods and apparatus which are effective and economical to employ.

It is a further object of the present invention to provide a system which effects high material removal while producing a very smooth and high-quality surface.

It is a further object of the present invention to provide a method and apparatus which achieves the desired low surface roughness average(s).

It is yet another object is the present invention to produce a workpiece which functions as an anode, and a grinding wheel which functions as a cathode which have an interposed circulating electrolyte.

It is a further object of the present invention to provide an automated power-driven rotational conformal conductive tool, such as a brush, to facilitate more efficient control of the electrolyte flow.

It is yet another object of the present invention to enhance the efficiency of finishing complex 3D AM-Fabricated metal parts by eliminating the need to use a grinding wheel, thereby significantly increasing the range of geometries which can be provided in the finished product.

It is yet another object in the present invention to employ a computer controlled conformal tool that includes either or both electrical conductivity and abrasiveness, such as a brush-type tool, which will conform over the complex 3D structures.

It is yet another object of the invention to provide a C-MDP system which can be employed with any electrically conductive material.

These and other objects of the invention will be readily apparent from the following detailed description and the appended claims.

### BRIEF DESCRIPTION OF THE DRAWINGS

FIG. 1 is a partially schematic elevational view of a prior art ECG system.

FIG. 2 is a partially schematic elevations view of a prior art MDP system.

FIG. 3 is a partially schematic elevational view of a robot employable in the present invention for C-MDP.

FIG. 4 is a detailed view of a portion of FIG. 3 showing the brush interaction with a workpiece.

FIG. 5 is a detailed view of a different form of brush usable with the robot of FIG. 3.

FIG. 6 shows a perspective section of a brush usable in the present invention which has both a plurality of radially oriented electrically conductive bristles and a plurality of radially oriented electrically insulative bristles.

FIG. 7 shows a perspective view of a brush usable in automated C-MDC conformal surface forming of complex shaped objects with precision in a single step.

FIG. 8 is a schematic illustration of a preferred control system for practicing the method of the invention.

FIG. 9 shows a schematic view of a computer controlled conformal system having automated precise positioning and operation of the brush and precise control of the electrolyte introduction to create precision conformal surface forming of additive manufactured products in a single process step.

FIG. 10 illustrates schematically a single bristle of a brush having a conductive core and nonconductive abrasive element secured to the exterior thereof.

FIG. 11 is a schematic illustration which provides details regarding the concepts of shape adaptive grinding with a conformal tool operating on an irregularly configured workpiece and also shows an alternate means of establishing electrolyte flow to the gap between the tool and the workpiece.

FIG. 11 shows a schematic illustration of a conformal tool operating on an irregularly configured workpiece.

FIG. 12 shows schematically details of the embodiment providing electrolyte flow through a passageway in the motor and brush sequentially to an outlet adjacent the gap between tool and the workpiece

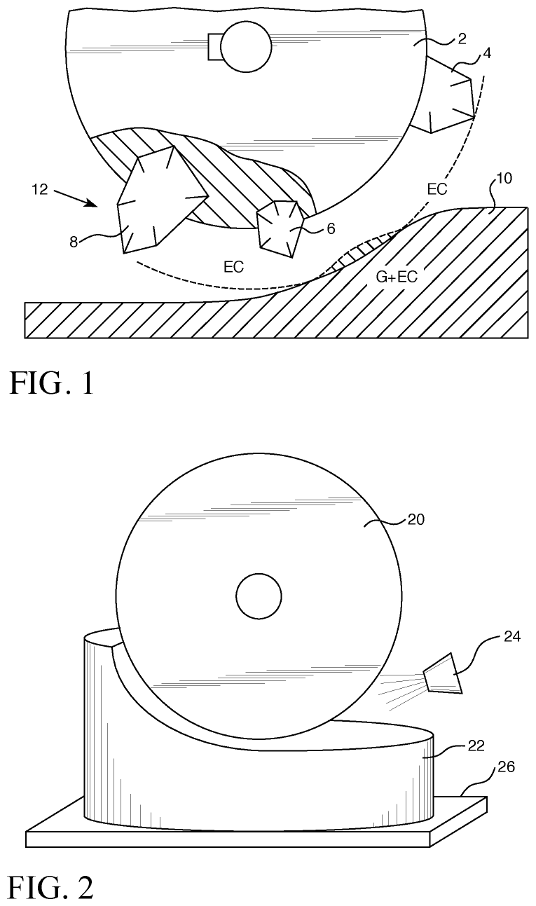

### DESCRIPTION OF THE PREFERRED EMBODIMENTS

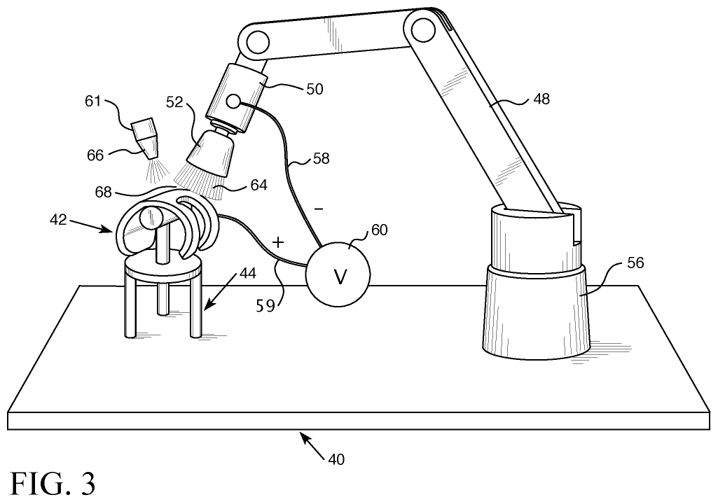

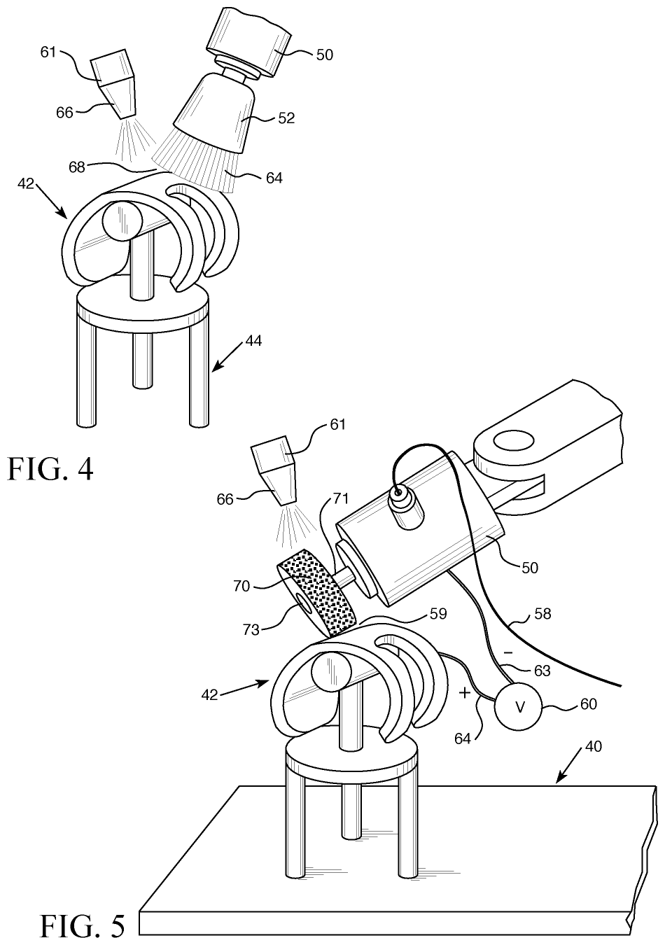

Referring now to FIGS. 3 through 5, there is shown one embodiment of the apparatus for practicing the method of the present invention in creating a product through the use of conformal molecular decomposition processes. For the overall device, another embodiment could be a 3 to 5 axis MDP machine (not shown). In addition to robotic controls, the controlled motion of the conformal head movement relative to the complex surface could be accomplished on a traditional three or five axis machining center. The part could remain stationary and the conformal head moved by the three or five axis machining center to correct orientation for the conformal head to be approximately perpendicular to the surface of the part. As shown in FIGS. 3 and 4, a support table 40 has a workpiece 42 secured thereto by a base 44. The workpiece 42 is electrically insulated from the rest of the system. In this embodiment, a robotic arm 48 has a base 56 which is fixedly secured to Table 40 while permitting relative movement between the base 56 and robotic arm 48. A motor (spindle) 50 for rotating brush 52 is secured to robotic arm 48. A power supply 60, which is connected to motor 50 by electrical lead 58 and to workpiece 42 by electrical lead 59, applies a negative voltage to the conformal tool 64, and a positive voltage to the workpiece 42. The motor (the on/off status and rotational speed) and the motions of the table are controlled by a computer numerical control (CNC) or similar control system. Motor 50 has its output shaft secured to brush 52 so as to permit rotation of the output shaft to effect rotation of brush 52. The free ends of the bristles of brush 52 are in sufficiently close proximity to the workpiece to permit the electrolyte delivered by electrolyte nozzle 66 to deliver electrolyte, between the workpiece 42 and brush 52 to a gap 68, so as to facilitate the desired treatment of the workpiece surface through the brush 52 conforming around the workpiece 42 with the desired spacing therebetween. The electrolyte nozzle 66 may be operably associated with a suitable electrolyte reservoir and pump 61 to deliver the electrolyte with the desired quantity and timing. As an effective amount of electrolyte is provided, the reservoir and pump serve to filter larger particles. In another embodiment, the electrolyte is supplied through the conformal tool.

FIG. 5 shows another embodiment, where the material removal occurs tangential to a brush 70 which has a modified configuration as compared with brush 52 which is shown in FIGS. 3 and 4. Brush 52 mainly removes material from its normal (end) surface, whereas brush 70 mainly removes material from its tangential surface. The brush 70 which is secured to shaft 71 which is in turn attached to motor 50 which is energized by electrical lead 58 which gets power from power source (not shown). The shaft 71 is coaxial with the brush hub 73. The electrolyte emerging from nozzle 66 enters the gap 50 between the brush 70 and workpiece 42 thereby producing the desired electrochemical reaction between the lateral portion of the brush 70 and the workpiece 42.

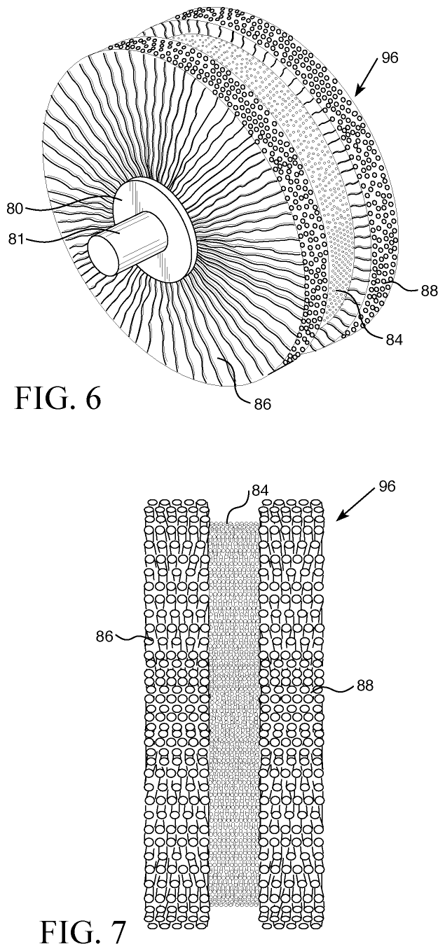

FIGS. 6 and 7 shows, respectively, a perspective section and an elevational section of a brush 96 usable in the present invention. The brush 96 has both a plurality of radially oriented electrically conductive bristles 84 and a plurality of radially oriented electrically nonconductive bristles 86, 88. Some examples of suitable conductive brush material include phosphorus, bronze, brass, aluminum, silver, nickel, or steel/plated steel for the conductive bristles. The non-conductive bristles could be made out of materials like aluminum oxide, silicon carbide, cubic boron nitride, flexible nylon or diamond. The conductive material needs to be able to withstand some sparking as the conductivity is turned on and off. Alloy choices for the bristles will minimize sparking conditions. The non-conductive material needs to be strong enough to not wear away quickly as at translates over a rough surface.

The brush 96 has a centrally located hub 80 to which a shaft 81 is fixedly secured. The conductive fibers 84 are operatively associated with shaft 81 to permit it to be energized therefrom. The current flows through the shaft 81 where the shaft enters hub 80 and contacts the bristles 84. The rotating shaft may be connected to the power supply through a slip ring mechanism. In the form shown, the central annulus 84 is composed of electrically conductive bristles which extend in a radial direction. The electrically nonconductive abrasive bristles 86,88 which extend radially farther outwardly than the electrically conductive adjacent bristles. The abrasive particles can be impregnated into or attached onto the electrically conductive bristles.

The brush 96 rotates on a shaft which can be generally vertical shaft, as in FIGS. 3 and 4, or a generally horizontally oriented shaft, as in FIG. 5. The brush speed is selected based on the desired surface quality and material removal.

The C-MDP process works when there is a specified gap 171 between the workpiece 170 and the conductive surfaces (end of the bristles 160). If the conductive surface is too far away, the C-MDP action does not take place. If there is direct contact creating an electrical short between the conductive surface and the workpiece, the process may work, but in an inefficient manner with unfavorable results. The C-MDP action works when the end of the bristles or the conductive portion of the C-MDP circuit is an acceptable distance from the material that is being polished, that is, when a “reverse electroplating” process of C-MDP is active. C-MDP creates an oxide on the surface, and this sludge and oxide is removed mechanically by the abrasive particles or the non-conductive abrasive bristles. If this layer is not removed, then the C-MDP action is slowed.

The size of the brush will be selected to correspond to the workpiece dimensions and the desired configuration of the workpiece.

It will be appreciated that alternative brush configurations could also be employed in achieving the desired results. For example, a brush wherein conductive and nonconductive bristles are interdigitated, could be employed as contrasted with the separate sections of FIGS. 6 and 7.

Additional alternate conformal tools may be employed advantageously in the present invention. For example, an inflatable membrane having secured thereto conductive portions. A further alternative would be to have cotton fibers with abrasive materials secured thereto. Yet another alternative would be to have an electrically conductive central core in the conformal tool for delivering current through the electrolyte to the workpiece.

It will be appreciated that with the present invention of C-MDP, even complex and curved surfaces can be can be polished and varying degrees of material can be removed with great precision without requiring multiple stages of operation. In the present system, the material removal amount is controlled to establish the final product within the specified dimensional accuracy and surface smoothness.

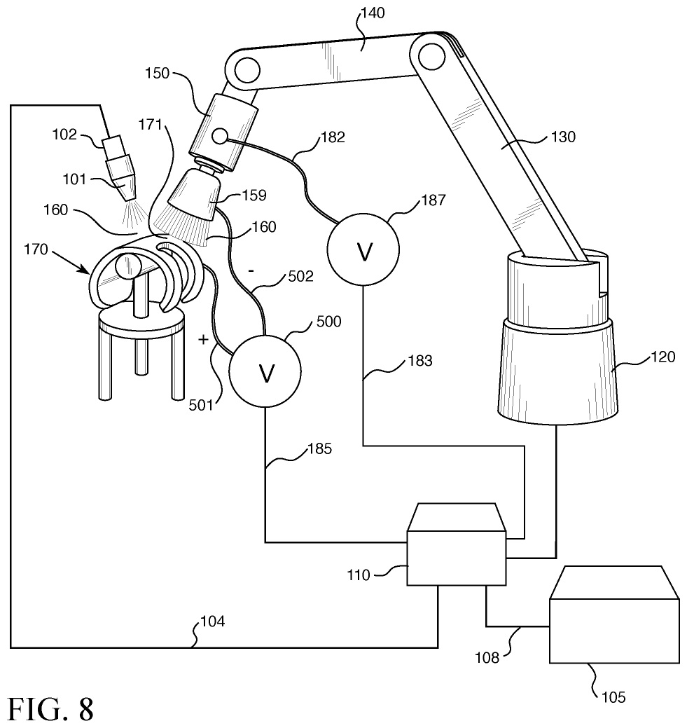

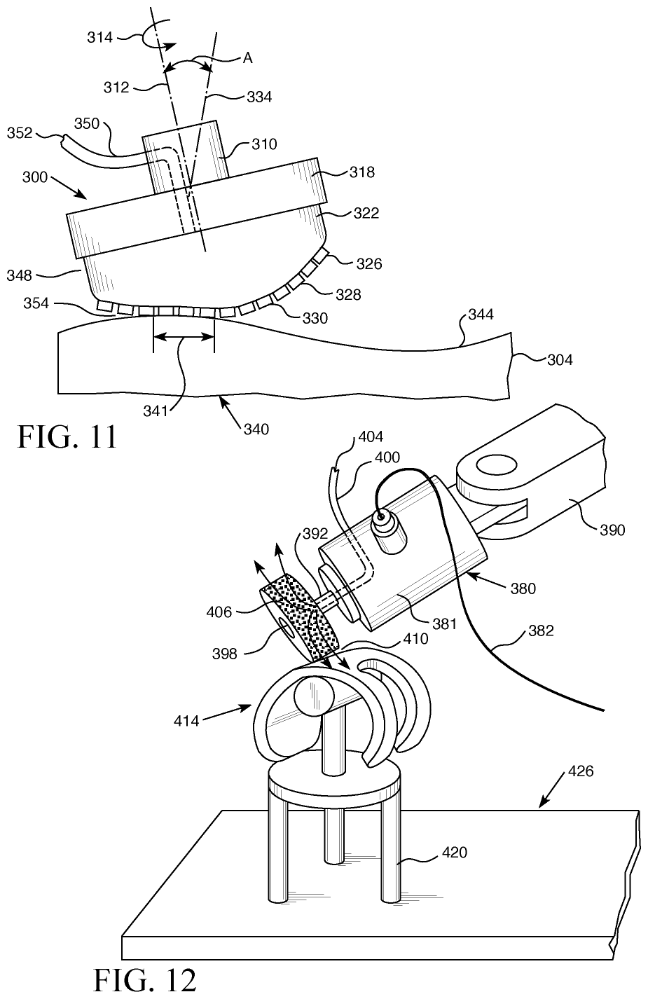

Referring in detail to FIG. 8 which shows a form of the apparatus employed to achieve the C-MDP precise configuration of the present invention. A power supply 105 supplies electrical power through wire 108 to programmed controller 110. Programmed controller 110 has been programmed to provide the operations needed to produce the conformal surface finished product being manufactured by the present invention without the use abrasive-containing grinding wheel. A stationary base 120 is secured to an underlying table (not shown in this view) or other suitable support. A robot arm 130 is secured to the base 120 and extends upwardly to arm portion 140. Secured to and extending downwardly from arm portion 140 is motor 150 which is controlled and electrically energized through electrical lead 182, 183 which is connected to controller 110. Power supply 500 which is controlled and electrically energized by controller 110 through lead 185 is connected to brush 160 by electrical lead 502 and to the workpiece by electrical lead 501 and, respectively, apply a negative voltage to the conformal tool or brush 160 and a positive voltage to the workpiece 170. Brush 159 which is connected to the lower end of motor 150 establishes axial rotation of the brush 159 at a speed and for a duration established by controller 110 through control of the speed of rotation of the output shaft of the motor 150. The brush 159 defines by one portion of the gap 171 which will receive the electrolyte with the other portion being defined by the stationary workpiece 170. The electrolyte enters the gap 171 in the form shown in FIG. 8 with an electrical lead 104 is connected to electrolyte pump 102 which causes electrolyte to emerge from nozzle 101. In the alternative, the electrolyte may pass through and emerge from the brush as shown in FIGS. 11 and 12 through the tooling itself. Material is removed from the workpiece by electrolytic action. The rotating brush 159 then employs mechanical action to remove the metal that has become soft through the electrochemical action and removal of the oxide surface using the nonconductive portions 86, 88 of the brush. The conductive portion 84 of brush 159 will remove material from the workpiece to establish the desired final workpiece configuration and finish. This may be accomplished in a single step without the need to engage in repeated process steps as in prior art.

The timing and amount of discharge of electrolyte through pump 102 (FIG. 8) is established by controller 110. Power supply and spindle engagement will be controlled to not operate without the electrolyte turned on.

This embodiment provides enhanced precision in the control and position of bristles 160 of brush 159. Before rotation of motor 150 to begin axial rotation of the brush 159 which may have the same construction as brush bristles 84, 86, 88 of FIGS. 6 and 7 the unit should be positioned so as to achieve the most effective placement of the brush 160 with respect to the workpiece and gap for electrolyte entry (not show in this view). The motor 150 will be energized and controlled through leads 182, 183 from controller 110. In an alternate embodiment, the brush may mounted so as to have oscillating movement to effect the desired electrolyte flow or so as to improve the material removal process.

The rate of flow of the electrolyte is preferably about 1-8 gallons a minute while through-the-spindle delivery will generally not require flow rates this high. The composition of the electrolyte solution may be a simple salt compound mixed with tap water.

Referring to FIGS. 6, 7 and 9 in greater detail, an enhanced version of the computer controlled system will be considered.

Motor 150 is controlled by controller 110 through line 182, 183. It controlled the period of motor operation and rotation of the output shaft which, in turn, determines the rotational speed of the attached brush 160. This positioning determines the gap between the workpiece 170 and the brush 160, which gap receives the flowing electrolyte.

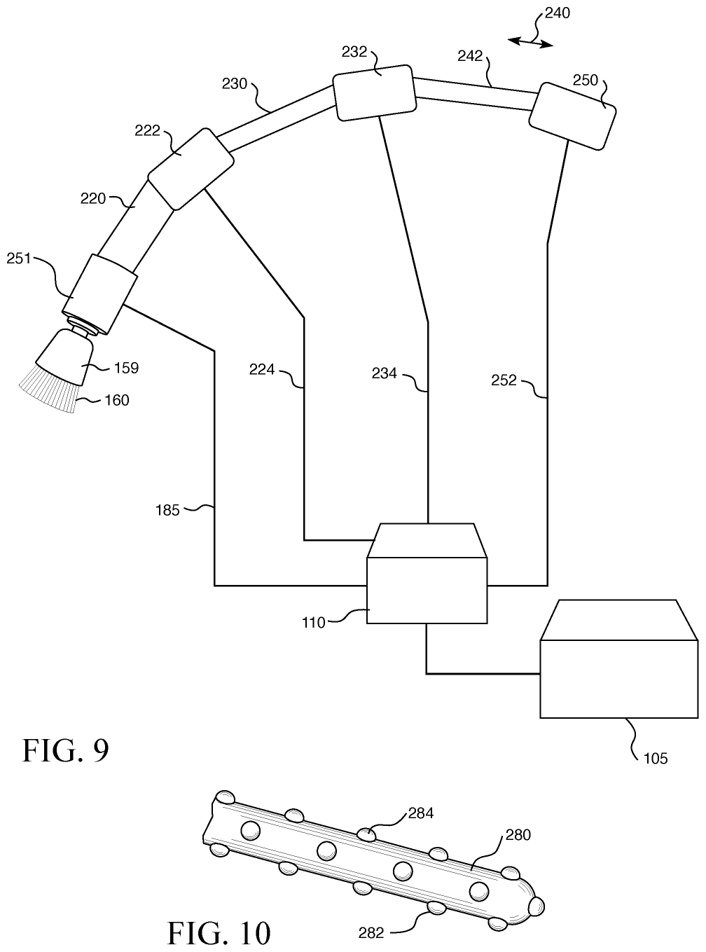

Referring to FIG. 9, details regarding the preferred automatic mode of positioning the brushes will be considered. The power supply 105 will supply energy to the controller 110 which will, in turn, energize other portions of the system. The controller 110 may be programed to perform the desired functions by means well known by computer programmers. Positioning of the workpiece with respect to the associated brush will establish the desired gap for appropriate electrolytic action in creating the conformal surface configuration through material removal in single creation of the desired shape and smoothness of complex configuration objects. The motor 250 controls the axial rotation of brush base 159 from which bristles 160 project. This embodiment of the invention provides for positioning of the bristles 160 through movement generally indicated by arrow 240. A stepping motor 222 is electrically energized through lead 224 and is secured to motor 250 through connector 220. Stepping motor 232 is energized through lead 234 and is connected to stepping motor 222 through connector 230. Stepping motor 251 is operatively associated with stepping motor 232 through connector 242 with energy being provided through electrical wire 130. Stepping motor 251 is energized through electrical lead 252.

FIG. 10 shows schematically a single bristle from a tool brush which contains an electrically conductive core 280 having on the exterior thereof a plurality of abrasive elements such as 282, 284, for example, fixedly secured to the exterior thereof. It will be appreciated, therefore, that in this embodiment all of at least some of the bristles may advantageously to have an electrically conductive core 280 to which has secured to the exterior thereof a plurality of outwardly projecting abrasive electrically nonconducting elements. See, for example, 282, 284. In an alternative embodiment, the tool brush may have bristles which have electrically conductive core 280 to which is secured a plurality of electrically conductive abrasive elements 282, 284 with electrically nonconductive shells covering and secured to the electrically conductive abrasive elements to thereby render the abrasive elements electrically nonconductive.

Referring to FIG. 11, there is shown schematically a conformal tool 300 operating on a workpiece 304. The tool 300 includes a spindle 310 which is rotatable about axis 312 as indicated generally by arrow 314. The spindle 310 is fixedly secured to a tool base 318. The tool 300 has an elastomeric portion 322 fixedly secured to base 318 and, in the form shown, projects generally downwardly with a plurality of projecting abrasive rigid pellets such as 326, 328, 330, for example, secured thereto. Angle A is the angle between a surface normal to the tool base 318 and the attack angle 334. The workpiece 304 which in the form shown is of a rectangular configuration, has a grinding area 341 disposed between the lower surface of tool 300 and the upper surface 344 of the workpiece 340. There is a gap 354 behind between the lower surface of the tool 300 and the upper surface of the workpiece 304.

In the embodiment of FIG. 11, a passageway 350 communicates with the exterior of the tool and runs through the spindle 310, base 318 and into the elastic portion 322 of tool 300. Electrolyte fluid introduced through opening 352 flows through the passageway 350 and emerges in gap 354 between tool 300 and workpiece 340 to thereby facilitate efficient adaptive grinding in accordance with the present invention.

FIG. 12 shows schematically another embodiment of the invention wherein the electrolyte flows through a passageway in the tool and brush for delivering the same to the gap between the tool and the workpiece.

A motor 380 is energized through an electrical wire 382. Motor 380 is operatively associated with a positioning actuator 390 and has an output spindle 392 fixedly secured to brush 398 to establish rotation thereof. A passageway 400 having an entrance 404 extends through the motor housing 381 and emerges and communicates with brush 398 in the region 406. The brush 398 has a gap 410 interposed between the periphery of the brush and workpiece 414. Initiating introduction of electrolyte flow into opening 410 in passageway 400 results in electrolyte flow into the gap 410 with the rotating brush 398 serving to recontour the workpiece 414 which has support 420 which in turn rests on base 426.

It will be appreciated that one of the applications of this technology is to improve the surface finish of AM parts, but the technology is not so limited. The process can also improve the surface finish of a cast, forged, machined, turned or ground metal part, for example. It can also improve the surface finish roughness as measured by Ra. It can further provide a more pristine surface that exhibits the appearance of the material composition of the original base material.

Whereas particular embodiments of the invention have been disclosed herein for purposes of illustration, it will be appreciated by those skilled in the art that numerous variations of the details may be made without departing from the invention as described in the appended claims.

What is claimed is:

1. A method of processing an electrically conductive workpiece comprising
providing a negatively charged conformal tool having abrasives secured thereto,
providing a positively charged electrically conductive workpiece,
providing an electrolyte receiving gap defined between said conformal tool and said workpiece to permit electrolyte to flow therethrough,
effecting relative movement between said conformal tool and said workpiece to electrolytically remove material from said workpiece, and
subsequently effecting engagement between said abrasives and said workpiece to mechanically remove a first layer of material from said workpiece.

2. The method of claim 1 including
said conformal tool being movable with respect to said workpiece.

3. The method of claim 2 including
said movable conformal tool is a rotatable brush.

4. A method of claim 2 including
said movable conformal tool having an elastomer with embedded abrasives.

5. The method of claim 2 including
said movable conformal tool is an inflatable membrane having attached nonconductive abrasives and conductive portions.

6. The method of claim 2 including
employing said method in creating additive manufactured products.

7. The method of claim 1 including
employing said process in improving the surface finish of a workpiece having a complex surface configuration.

8. The method of claim 1 including
said conformal tool having cotton fibers with abrasive materials secured thereto.

9. The method of claim 3 including
said conformal tool having an electrically conductive central core for delivering current through said electrolyte to said workpiece.

10. The method of claim 8 including
said conformal tool having a portion provided with a rubber composition having an electrically conductive portion secured thereto.

11. The method of claim 1 including
said conformal tool having a brush with bristles structured to have a construction selected from the group consisting of (a) a conductive core and nonconductive abrasive elements and (b) a nonconductive core and conductive abrasives elements.

12. The method of claim 1 including
said conformal tool having a passageway defined therein for flow of electrolyte to said gap.

13. The method of claim 1 including
electrolyte being delivered directly to said gap from a source external to said conformal tool.

14. The method of claim 1 including
introducing electrolyte into said gap, and
facilitating electrolyte flow through relative motion between said conformal tool and said workpiece to thereby electrically remove a first layer of material from said workpiece electrolytically.

15. The method of claim 14 including
subsequently to said removal of said first layer, mechanically removing additional material from said workpiece.

16. The method of claim 1 including
establishing the desired conformal configuration in a single process step.

17. The method of claim 1 including
establishing the desired conformal configuration by sequential action of said electrolytic action and mechanical action on said workpiece by said conformal tool.

18. The method of claim or 3 including
said brush being of generally circular configuration, and
said brush having a hub connected to an output shaft of a motor for rotating said brush about the axis of said shaft.

19. The method of claim 18 including
said brush having a plurality of generally radially oriented bristles, and
a first layer of said bristles being electrically conductive and at least one second layer of said bristles being electrically nonconductive.

20. The method of claim 19 including
said brush having generally radially oriented second layers of electrically nonconductive abrasive bristles disposed on opposite sides of said first layer of conductive bristles.

21. The method of claim 20 including
said bristles of said second layers being of greater length than the bristles of said first layer.

22. Apparatus for processing electrically conductive workpieces comprising
a negatively charged conformal tool having abrasives secured thereto,
a positively charged conductive workpiece,
said conformal tool and said workpiece being relatively spaced apart to establish a gap for flow of the electrolyte therebetween,
said conformal tool and said workpiece being structured to be relatively movable with respect to each other such that first portions of said workpiece surface may be removed electrolytically, and
subsequently second portions of said workpiece may be removed mechanically to establish the desired workpiece surface finish and shape.

23. The apparatus of claim 22 including
an electrolyte supply source for delivering electrolyte to said gap.

24. The apparatus of claim 23 including
said electrolyte supply source including a pump and nozzle for delivering said electrolyte to said gap.

25. The apparatus of claim 23 including
said electrolyte supply source including at least one passageway formed within said conformal tool for delivering said electrolyte to said gap.

26. The apparatus of claim 23 including
said conformal tool being a rotatable brush structured through conformal molecular decomposition to remove portions of said workpiece by electrolysis and subsequently remove portions of said workpiece mechanically.

27. The apparatus of claim 26 including
said apparatus structured to effect such workpiece processing in a single cycle of operation.

28. The apparatus of claim 26 including
an electrolyte supply pump for delivering electrolyte to said gap,
a robotic arm supporting said brush and said motor,
a computerized controller for controlling operation of said conformal tool,
said electrolyte supply pump,
a power supply operatively associated with said computerized controller to energize said system, and
a computational algorithm to control the location and the gap between said conformal tool and said workpiece.

29. The apparatus of claim 26 including
said brush having a centrally disposed first radially oriented group of electrically conductive bristles, and
said brush having a second layer of radially oriented electrically nonconductive bristles disposed on opposite sides of said first radially oriented layer.

30. The apparatus of claim 29 including
a stepper motor secured to said brush rotating motor and being structured to move said brush rotating motor in small increments to position the brush.

31. The apparatus of claim 29 including
the bristles of said second layer being of greater length than the bristles of said first layer.

32. The apparatus of claim 28 including
a robot arm operatively associated with an actuator secured to said robotic arm for altering the position of said stepping motor.

33. The apparatus of claim 23 including
a product made by a work product finished by the process of claim 1.

34. The apparatus of claim 23 including
said movable conformal tool having an elastomer with embedded abrasives.

35. The apparatus of claim 23 including
said movable conformal tool is an inflatable membrane having attached conductive portions and attached nonconductive portions.

36. The apparatus of claim 23 including
said conformal tool having cotton fibers with abrasive materials secured thereto.

37. The apparatus of claim 23 including
the product made by the method of claim 1.

38. The apparatus of claim 23 including
the product made by the apparatus of claim 22.
